(19) United States
(12) Patent Application Publication
(10) Pub. No.: US 2010/0023757 A1
(43) Pub. Date: Jan. 28, 2010

(54) METHODS AND SYSTEMS FOR SENDING SECURE ELECTRONIC DATA

(75) Inventors: Thi Chau Nguyen-Huu, Mississauga (CA); Julian Petrov Michailov, Mississauga (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: WINMAGIC DATA SECURITY, Mississauga (CA)

(21) Appl. No.: 12/505,146

(22) Filed: Jul. 17, 2009

Related U.S. Application Data
(60) Provisional application No. 61/082,685, filed on Jul. 22, 2008.

(51) Int. Cl. H04L 9/32; H04L 9/08; G06F 15/16

(52) U.S. Cl. 713/156; 380/282; 709/206

(57) ABSTRACT

A method and system for providing encryption are provided, involving a) transmitting a request from a sender to a database for a public key for a selected recipient, the database being configured to store for each member in a plurality of members a member public key for encrypting electronic data; b) determining if the selected recipient is in the plurality of members, and; c) if the selected recipient is in the plurality of members, then executing a member procedure, the member procedure comprising transmitting from the database to the sender the member public key stored in the database for the selected recipient; d) if the selected recipient is not in the plurality of members, then executing a non-member procedure, the non-member procedure comprising determining if at least one predetermined criterion is met, and, if the at least one predetermined criterion is met, generating a non-member public key for encrypting electronic data and a non-member private key for decrypting the electronic data encrypted using the non-member public key; otherwise, if the at least one predetermined criterion is not met the non-member public key and the non-member private key are not generated.

This is a non-provisional application of U.S. Application No. 61/082,685 filed Jul. 22, 2008. The contents of U.S. Application No. 61/082,685 are incorporated herein by reference.

### FIELD OF THE INVENTION

The invention generally relates to encryption, and more particularly, relates to methods and systems for members and non-members of an encryption system to send secure electronic data (e.g. e-mail).

### BACKGROUND

Electronic data communication is increasing in both importance and prevalence. In some situations, it can be important to take steps to try and maintain the confidentiality and security of electronic data being communicated. Accordingly, there remains a need for methods and systems for facilitating secure communication of electronic data.

### SUMMARY

In accordance with an aspect of an embodiment of the invention, there is provided a method for providing encryption. The method comprises: a) transmitting a request from a sender to a database for a public key for a selected recipient, the database being configured to store for each member in a plurality of members a member public key for encrypting electronic data; b) determining if the selected recipient is in the plurality of members, and; c) if the selected recipient is in the plurality of members, then executing a member procedure, the member procedure comprising transmitting from the database to the sender the member public key stored in the database for the selected recipient; d) if the selected recipient is not in the plurality of members, then executing a non-member procedure, the non-member procedure comprising determining if at least one predetermined criterion is met, and, if the at least one predetermined criterion is met, generating a non-member public key for encrypting electronic data and a non-member private key for decrypting the electronic data encrypted using the non-member public key; otherwise, if the at least one predetermined criterion is not met the non-member public key and the non-member private key are not generated.

In accordance with an aspect of a second embodiment of the invention, there is provided a method for providing encryption. The method comprises: a) transmitting a request from a sender to a database for a public key for a selected recipient, the database being configured to store for each member in a plurality of members a member public key for encrypting electronic data; b) determining if the selected recipient is in the plurality of members, and; c) if the selected recipient is in the plurality of members, then executing a member procedure, the member procedure comprising transmitting from the database to the sender the member public key stored in the database for the selected recipient; d) if the selected recipient is not in the plurality of members, then executing a non-member procedure, the non-member procedure comprising generating a non-member public key for encrypting electronic data and a non-member private key for decrypting the electronic data encrypted with the non-member public key.

In accordance with an aspect of a third embodiment of the invention, there is provided a system for providing encryption. The system comprises a database and an end entity. The database comprises: a storage module configured to store, for each member in a plurality of members, a member public key for encrypting electronic data; a communication module configured to receive a request from a sender for the member public key for a selected recipient; a key generation module configured, upon activation, to generate a non-member public key for encrypting electronic data and a non-member private key for decrypting the electronic data encrypted with the non-member public key; and, a key management module configured to determine whether the selected recipient is in the plurality of members, and if the selected recipient is in the plurality of members, transmit to the sender the member public key stored in the database for the selected recipient; and if the selected recipient is not in the plurality of members, then activate the key generation module. The end entity is associated with the sender, and is configured to transmit the request.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of a system for sending secure electronic data in accordance with at least one embodiment;

FIG. 2 is a flowchart illustrating method for a member to enroll in an encryption system in accordance with at least one example embodiment; and

FIG. 3 is a flowchart illustrating a method for a member of an encryption system to send secure electronic data in accordance with at least one example embodiment.

### DETAILED DESCRIPTION

The described embodiments relate to methods and systems for securely sending electronic data (e.g. e-mail) using a public key encryption system such as public key infrastructure (PKI). PKI is a framework that enables users to securely and privately exchange data over a network, such as the Internet or an intranet through the use of public key cryptography.

In public key cryptography, a public and private key are created simultaneously using the same algorithm (e.g. RSA (Rivest-Shamir-Adleman), DSA (Digital Signature Algorithm), Diffie Hellman, or ECC (Elliptic Curve Cryptography)). The private key is given only to the requesting party and the public key can be passed openly between the parties or published in a public repository. Data encrypted with the public key can be decrypted only using the private key. Data encrypted with the private key can be decrypted only using the public key. Accordingly, any individual can send the holder of a private key a message encrypted using the corresponding public key and only the holder of the private key can decrypt the secure message. Similarly, the holder of a private key can establish the integrity and origin of the data sent to another party by digitally signing the data using his private key. Anyone who receives that data can use the associated public key to validate that it came from the holder of the private key and verify the integrity of the data has been maintained.

Public keys may be distributed in the form of public key certificates (which may be referred to simply as certificates). A public key certificate is a digitally signed electronic document that binds a public key to the identity of a subject (this can be a person, computer or service) that holds the corresponding private key. The public key certificate is typically signed by a certification authority and by signing the certificate the certification authority attests that the private key associated with the public key in the certificate is in the possession of the subject named in the certificate.

Typically public key certificates contain the following information: the public key being signed, the subject's identity information (i.e. name and e-mail address), the dates between which the certificate is valid, the certificate's serial number, the name of the certification authority that issued the certificate and the key that was used to sign the certificate, an identifier of the policy that the certification authority followed to establish that the end entity is who it says it is, the uses of the key-pair (the public key and the associated private key) identified in the certificate and the location of the certificate revocation list (CRL). The CRL is a document maintained by the certification authority that lists certificates that have been revoked.

There are many well-known certificate standards such as the X.509v3 certificate standard. X.509v3 is version 3 of the International Telecommunication Union Standardization Sector (ITU-T) recommendation X.509 for certificate syntax and format.

A certificate is valid only for the time period specified within it. Every certificate contains Valid From and Valid To dates, which set the boundaries of the validity period. Once a certificate's validity period has passed, the subject of the now-expired certificate must request a new certificate.

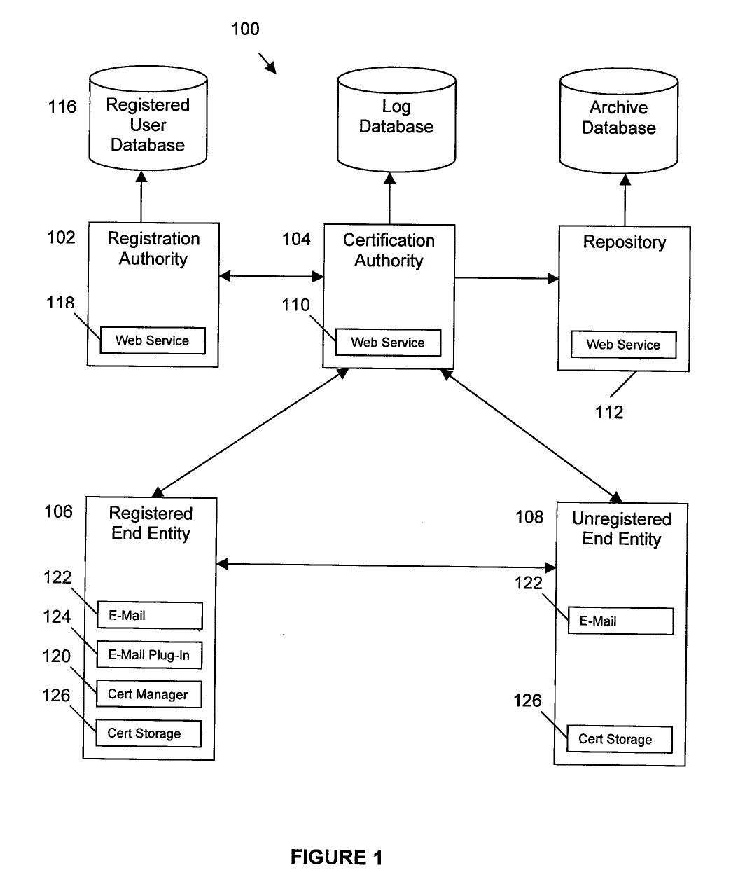

Reference is now made to FIG. 1, in which a system 100 for securely sending electronic data (e.g. e-mails) in accordance with an embodiment is illustrated. The system 100 includes a registration authority (RA) 102, a certification authority (CA) 104, a repository 112, a member end entity 106 and a non-member end entity 108.

The CA 104 (also referred to as a trusted third party TTL) issues certificates to requesting end entities 106 and 108. The CA 104 may be a server running a standard operating system such as Windows-based operating system (e.g. Windows Server 2003), LINUX or UNIX.

The CA 104 receives certificate requests from the end entities 106 and 108 via a web service 110 running on the CA 104. The certificate request may either be an enrollment request in which the requester is asking for their own certificate, or a recipient request in which the requestor is asking for the certificate of a recipient of an electronic message (e.g. e-mail). A web service is an application that can be invoked through the Internet. Web Services are typically accessed by other computer applications that communicate, usually over HTTP, using XML standards including SOAP, WSDL, and UDDI.

In one embodiment the CA 104 maintains a list of members of the system 100 along with certain identifying information. The identifying information may include the member's first name, last name, e-mail address and PIN number. The names of the members and their identifying information may be entered into the CA 104 via an administration portal of the web service 110. For example, a company may have a list of employees that it wishes to register as members of the system 100. A system administrator may compile the list of employees along with the identifying information and load the information onto the CA 104 via the administration portal of the web service 110. The information may, for example, be compiled in a spreadsheet according to a predetermined format and then uploaded to the CA 104. The member information may alternatively be entered manually by the potential member via a web interface or other suitable interface.

In some embodiments the CA 104 may approve or reject members based on a predetermined policy. For example, the CA 104 policy may be to disallow e-mail addresses from a specific country or from a public e-mail service such as Hotmail. Once the CA 104 has approved of a potential member that member is said to be registered with the CA 104.

Once a member has been registered with the PKI system, the member has to enroll in the system. Enrollment is the process whereby a member makes itself known to the CA 104 and receives its public key certificate. In some cases the member may receive an invitation to enroll with the CA 104. For example, once a CA 104 has registered a member, the CA 104 may automatically send the member an invitation (e.g. e-mail message) to enroll with the CA 104. Typically enrollment involves the member sending the CA 104 an enrollment request which contains the member's identifying information. When the CA 104 receives an enrollment request it first verifies the identifying information provided by the requester.

If the identifying information is verified, the CA 104 generates a member public key certificate and digitally signs it. In some embodiments generation of the member public key certificate involves first generating a private and public key pair and then generating a member public key certificate including the public key. In these embodiments the private key and the member public key certificate are stored in the repository 112 and transmitted to the member.

In other embodiments the member supplies the CA 104 with a previously generated public key and the CA 104 only generates and signs a public key certificate containing the public key provided. In these embodiments only the generated public key certificate is stored in the repository 112 and transmitted to the requester.

The CA 104 may also be responsible for issuing CRLs. CRLs list serial numbers of certificates that the CA 104 considers no longer usable. As noted above, certificates have a specified lifetime, but the CA 104 can reduce this lifetime by a process known as certificate revocation. The CA 104 may include in the CRL the reason why the certificate has been revoked. The following reasons may be specified for revoking a certificate: key compromise, CA compromise, affiliation changed, superseded, cessation of operation or certificate hold. The specified lifetime of CRLs is typically much shorter than that of a certificate.

The CA 104 may also store a non-member certificate status indicator for each member. The non-member certificate status indicator indicates whether a non-member certificate is available. Typically members of an encryption system such as PKI can only securely send electronic data to other members of the encryption system. A non-member certificate is a certificate that is assigned to a non-member of the encryption system so that they can receive secure electronic data. The non-member certificates may not specifically identify the holder of the corresponding private key, but may use a generic identifier such as “free certificate” or “non-member certificate”. When a member wants to securely send electronic data to a recipient and the member does not have the recipient's public key certificate, the member sends a request to the CA 104 to retrieve the recipient's public key certificate. If the CA 104 determines that the recipient is a member then the CA 104 sends the member the recipient's public key certificate stored in the repository 112. If the CA 104 determines that the recipient is not a member then the CA 104 checks the member's non-member certificate status indicator to determine whether the sender has a non-member certificate available. If the member has a non-member certificate available then the CA 104 generates a public and private key pair and corresponding non-member public key certificate for the recipient. The CA 104 may then store the private key and corresponding non-member public key certificate in the repository 112.

In some cases the non-member certificate status indicator can be a number that indicates how many non-member certificates are available to the member. In this case the non-member certificate status indicator may be decreased each time the CA 104 generates a non-member certificate for a non-member recipient. The CA 104 will continue to generate and assign non-member certificates to non-member recipients at the request of the member so long as the non-member certificate status indicator indicates that the member has at least one unused non-member certificate.

In other cases the non-member certificate status indicator is a Boolean value that indicates whether the member has available non-member certificates. In this case the Boolean value may be tied to a specific time period. For example, the non-member certificate status indicator may be set to “yes” for 3 months and then may automatically set to “no” after expiration of the three months unless the member decides to purchase additional non-member certificates.

Each non-member certificate, like each member certificate, is issued with an expiry date. The period between the issue date and the expiry date will be referred to as the validity period. The validity period for a non-member certificate may be the same or different than the validity period for a member certificate. For example, the validity period of non-member certificates may be shorter than the validity period of member certificates. Having a shorter validity period for non-member certificates means that the non-member must make a decision sooner whether they want to join the encryption system or not. Making the validity period for non-member certificates too short though may not allow the non-member to become “hooked” on the encryption system. In one embodiment a member certificate has a validity period of 1 year and a non-member certificate has a validity period of six months. The CA 104 may be configured to monitor the validity period of the non-member certificates and when the validity period of a non-member certificate expires, transmit a membership invitation to the non-member inviting the non-member to become a member of the encryption system.

In one embodiment each member is assigned a predetermined number of non-member certificates upon registration. The specific number of non-member certificates assigned may be based on the “level” of the member. For example, membership in the encryption system may be offered at different member levels such as gold, silver and bronze. A gold level member would be assigned a higher number of non-member certificates than the silver and bronze levels and may have other privileges such as having the option to purchase additional non-member certificates. The additional perks of gold membership, however, could come at an increased membership cost over silver and bronze membership.

A remote third party, such as VeriSign or Thawte, may operate the CA 104 or a company or institution can build its own internal CA.

The RA 102 is coupled to the CA 104 via a network such as the Internet or an intranet and may be delegated a number of the CA 104 functions. Functions that may be delegated to the RA 102 include, but are not limited to, establishing an environment and procedure for certificate applicants to submit their certificate applications, identification and authentication of individual or identities applying for a certificate, the approval or rejection of certificate applications, the initiations of certificate revocations, either at the user's request or upon the entity's own initiative, and the identification and authentication of individuals or entities submitting requests to renew certificates.

In one embodiment the RA 102 is responsible for approval or rejection of potential members. In an alternate embodiment the RA 102 maintains the list of members of the system along with the identifying information. In this embodiment when the CA 104 receives an enrollment request it sends a verification request to the RA 102. If the RA 102 verifies the requester then the CA 104 generates the public key certificate and signs it. As described above, generation of the public key certificate may or may not include generation of a public and private key pair. If the user supplies the CA 104 with a previously generated public key then the CA 104 only generates and signs a certificate containing the previously generated public key. If the user does not supply a previously generated public key then the CA 104 must first generate a public and private key pair.

In another embodiment RA 102 is not delegated any of the CA 104 functions; thus, in this embodiment, all CA 104 and RA 102 functions described above are performed by the CA 104.

The RA 102 may be a server running a standard operating system such as Windows-based operating system (e.g. Windows Server 2003), LINUX or UNIX.

The repository 112 is a directory for storing and retrieving encryption system information such as certificates and CRLs. In one embodiment the repository 112 is an X.500-based directory with access via the Lightweight Directory Access Protocol (LDAP). The repository 112 is coupled to the CA 104 via a network such as the Internet.

As described above, system 100 also includes one or more member end entities 106 and one or more non-member end entities 108. A member end entity 106 is an end entity that is associated with a member of the system 100. A non-member end entity 108 is, by extension, an end entity that is not associated with a member of the system 100. The member end entity 106 can be a computer system with a certificate manager module 120, an electronic data module 122, a secure transmission module 124 and a certificate storage module 126. The non-member end entity 108 may also be a computer system, but it may only have an electronic data module 122 and a certificate storage module 126.

The certificate manager module 120 is responsible for transparently obtaining and managing certificates on the end entity 106. In one embodiment the certificate manager module 120 is implemented as a service which runs automatically when the end entity 106 starts up. The certificate manager module 120 may perform the following three functions: (1) assisting the end entity 106 in enrolling in the encryption system; (2) obtaining and managing the public key certificates of other members and non-members of the encryption system; and (3) obtaining the latest CRL from the CA 104 and updating the certificate list in response.

As described above, members must enroll in the encryption system before they can transmit or receive secured messages. In some embodiments the certificate manager module 120 can be invoked to initiate the enrollment process. Specifically, the certificate manager module 120 when invoked provides the user with a pop-up window where they are prompted to specify all of their identifying information. As stated above, identifying information may include the first name, last name, e-mail address and PIN number for the member. In some embodiments the member may create its own public and private key pair and thus the pop-up window may provide a section where the user can identify a public key previously generated.

Once all of the information has been entered the certificate manager module 120 sends the enrollment request to the CA 104. If the enrollment information is verified, the CA 104 responds with a signed member public key certificate. The certificate manager module 120 receives the member public key certificate and registers the member public key certificate with the electronic data module 122. The certificate manager module 120 also registers the member public key certificate with the certificate storage module 126. If the user did not supply a previously generated public key then the CA 104 will also provide the user with their private key. The certificate manager module 120 will similarly receive the private key and register the private key with the electronic data module 122.

The certificate manager module 120 may also be configured to poll the CA 104 at a set interval to determine if there have been any new enrollments. If there have been new enrollments, the certificate manager application 120 obtains the new enrollment's public key certificate and registers it with the electronic data module 122 and the certificate storage module 126. Alternatively, the certificate manager module 120 may be configured to listen for public key certificate updates issued periodically by the CA 104 and when one is received it will automatically register it with the electronic data module 122 and the certificate storage module 126.

The certificate manager module 120 also may be configured to poll the CA 104 for the latest CRL. If there is a new CRL the certificate manager module 120 notifies the electronic data module 122 of any changes to the status of the certificates used by the end entity 106. Alternatively, the certificate manager module 120 may be configured to listen for CRL updates that are periodically issued by the CA 104.

The electronic data module 122 allows an end user to generate and send electronic data, and to receive electronic data. Where the electronic data being transmitted and received are e-mail messages, the electronic data module 122 may be a standard e-mail application such as Microsoft™ Outlook, Microsoft™ Outlook Express and Lotus Notes™.

The secure transmission module 124 is an add-on to the electronic data module 122 that allows a user to easily send secure electronic data to selected recipients. The electronic data module 122 may add a secure transmission link to the electronic data module 122 that can be activated by the user. For example, where the electronic data module 122 is an e-mail application, the secure transmission module 124 may add a new button, referred to as the “send secure” button, to the e-mail application toolbar. When the “send secure” button is clicked the secure transmission module 124 encrypts the e-mail message using the certificate associated with the recipient prior to sending it to the recipient. In some embodiments the “send secure” button also triggers digital signing of the e-mail message prior to sending it to the recipient.

The certificate storage module 126 stores the certificates on the end entity 106 or 108. The certificate storage module 126 may be a standard certificate storage package such as Microsoft™ Certificate Store or the like.

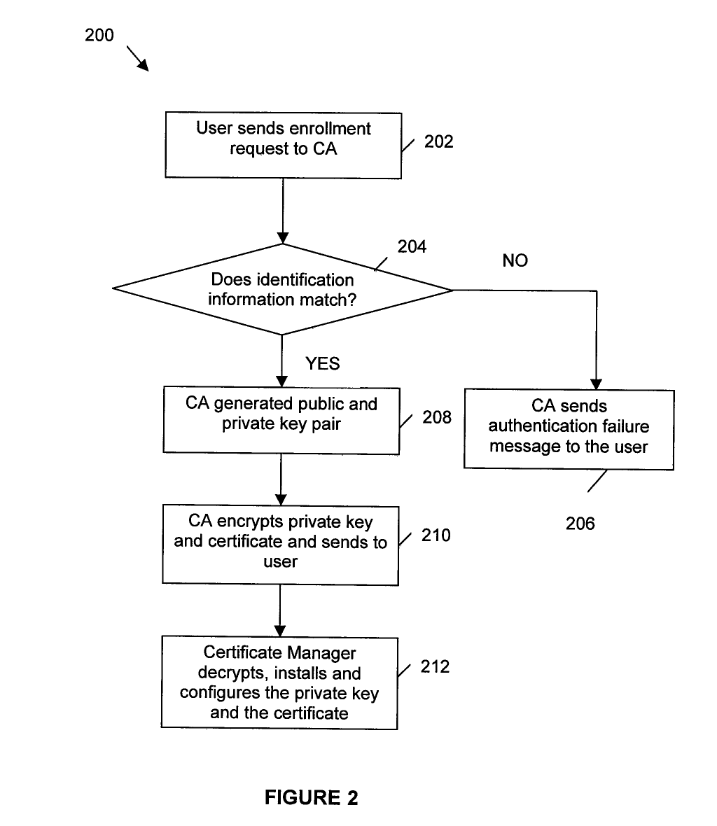

Reference is now made to FIG. 2, in which a method 200 for a member to enroll in an encryption system in accordance with an embodiment is illustrated in a flowchart. In step 202, a user at a member end entity 106 initiates an enrollment request to the CA 104. The enrollment request may be initiated by activating the certificate manager module 120 and entering the member's identifying information. In one embodiment the identifying information includes the user's first name, last name, e-mail address and PIN number. Where the user has generated their own private and public key pair, the user will also provide the previously generated public key to the certificate manager module 120. The enrollment request, which includes the identifying information and any previously generated public key, may be sent via a SSL (Secure Socket Layer) socket to the CA 104.

SSL is a protocol for transmitting private documents via the Internet. SSL uses a program layer located between the HTTP and TCP (transport control protocol) layers. The data is passed back and forth in sockets. SSL uses the public-and-private key encryption system from RSA, which also includes the use of a digital certificate.

In query 204, the CA 104 receives the enrollment request generated in step 202 and identifies and authenticates the user. The authentication involves comparing the identifying information with the information in the CA 104. If query 204 indicates the identifying information does not match an entry then the enrollment process is prematurely terminated and the method proceeds to step 206. In step 206 the CA 104 sends a message to the end entity 106 notifying them of the failed authentication. Once a failed authentication message is received the user must restart the enrollment process to receive a signed public key certificate.

If query 204 indicates that the identifying information matches an entry then the method proceeds to step 208. In step 208 the CA 104 generates and signs a member public key certificate. Where the user has generated their own public and private key pair then CA 104 simply generates a member public key certificate containing the public key received from the member and signs it. If however, the user has not generated their own public and private key pair then the CA 104 must first generate the public and private key pair prior to generating the member public key certificate and signing it. Where the CA 104 generates the public and private key pair, the CA 104 stores the private key and corresponding member public key certificate in the repository 112. Otherwise the CA 104 stores only the member public key certificate in the repository 112.

In step 210, the CA 104 sends the generated information to the member end entity 106. For example, where the CA 104 generates the public and private key pair and the member public key certificate the CA 104 sends both the private key and the member public key certificate to the member end entity 106. Where the CA 104 generates only the member public key certificate the CA 104 sends only the member public key certificate to the member end entity 106. The CA 104 may encrypt the member public key certificate and/or private key with the PIN number associated with the request and send it to the end entity 106 via a SSL socket.

In step 212 the certificate manager module 120 of the member end entity 106 receives the member public key certificate and/or private key sent in step 210. Where the member public key certificate and/or private key were encrypted by the CA 104 prior to transmission they must be decrypted using the PIN number entered by the user in step 202. The certificate manager module 120 then registers the received member public key certificate and/or private key with the electronic data module 122 and registers the member public key certificate with the certificate storage module 126. Once the private key is registered with the electronic data module 122 the end entity 106 is able to decrypt any electronic data (e.g. e-mail) encrypted using its public key.

However, the end entity 106 cannot securely send any electronic data until it receives the public key of the recipient. In one embodiment, the CA 104 is configured to push public certificates to all enrolled members when a new member enrolls with the CA 104. In an alternative embodiment, the certificate manager module 120 is configured to poll the CA 104 on a periodic basis for the public certificates of new members.

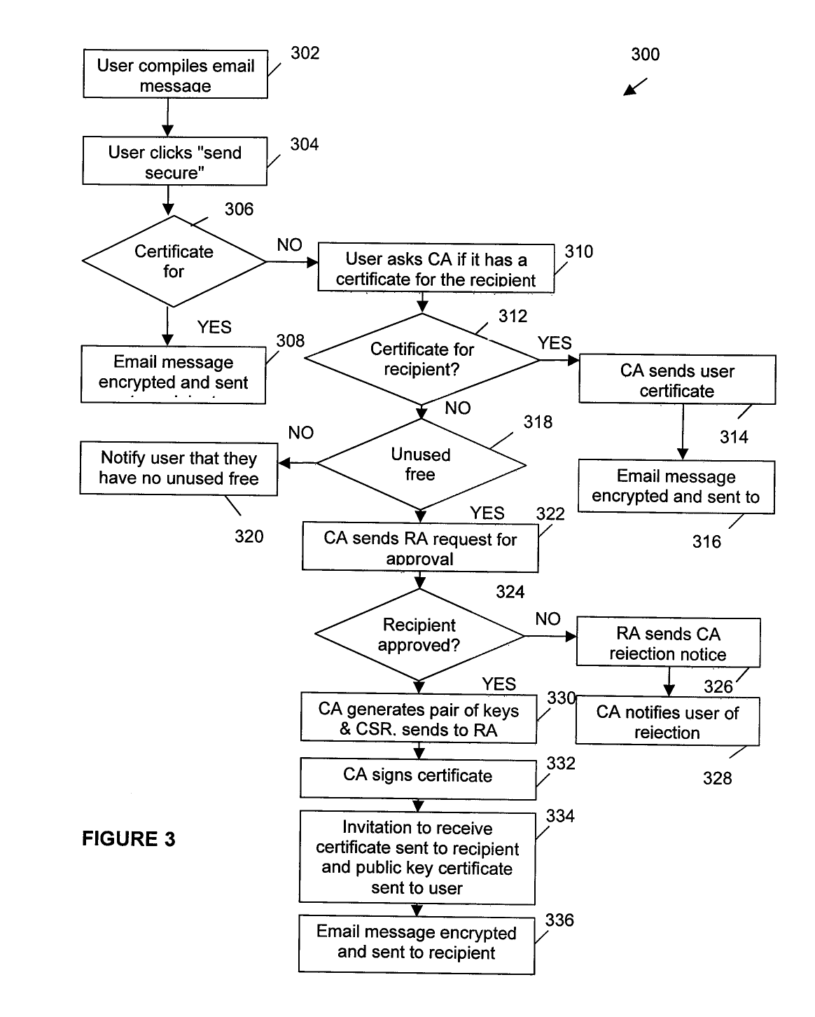

Reference is now made to FIG. 3 in which a method 300 for a member of an encryption system to send secure electronic data (e.g. e-mail) in accordance with an embodiment is illustrated in a flowchart. In step 302 a sender of electronic data invokes the electronic data module 122 and generates electronic data (e.g. an e-mail message) to be sent to a selected recipient. As described above, the electronic data module 122 may be an e-mail application that allows the user to generate an e-mail message to a selected recipient. It should be noted that electronic data may be sent to more than one recipient, but for ease of explanation the process of securely sending electronic data will be described in reference to electronic data sent to one recipient.

In step 304 the sender initiates the secure transmission of the electronic data by invoking the secure transmission module 124 via the secure transmission link provided in the electronic data module 122. As described above, the secure transmission link may be a button (e.g. a “send secure” button) that appears in the toolbar of an e-mail application.

In query 306 the secure transmission module 124 checks to see if there is a public key certificate for the selected recipient configured on the member end entity 106. Where the electronic data module 122 is an e-mail application, the secure transmission module 124 may check the e-mail application contact list to determine if there is a certificate for the selected recipient.

If query 306 determines there is a public key certificate for the selected recipient configured on the member end entity 106 then the method proceeds to step 308. In step 308 the secure transmission module 124 encrypts the electronic data using the public key certificate and sends it to the recipient. In some embodiments the secure transmission module 124 may also digitally sign the electronic data using the sender's private key prior to sending it to the recipient. The private key used for signing may be the same private key that is used to decrypt electronic data sent to the member or it may be a special private key used only for signing. Digitally signing a document may comprise generating a hash value from the electronic data and then encrypting the hash value using the private key.

If query 306 determines there is no public key certificate for the selected recipient configured on the member end entity 106 then the method proceeds to step 310. In step 310 the secure transmission module 124 obtains the identifying information for the recipient. In one embodiment the secure transmission module 124 displays a window that prompts the user to enter the identifying information. In an alternate embodiment the secure transmission module 124 automatically obtains the identifying information from the information entered by the user when generating the electronic data. The identifying information may include the first name, last name, e-mail address and PIN number for the recipient. The user may also be prompted to specify whether the CA 104 should generate a signing or authentication certificate for the recipient in addition to an encryption certificate. Optionally, the user can also be prompted to provide identifying information for the recipient. Alternatively, the user can be prompted to enter this information after the CA determines the recipient is not a member. The secure transmission module 124 then sends a request to the CA 104 for the public key certificate for the recipient.

In query 312 the CA 104 determines if the recipient is a member of the encryption system. Determining if the recipient is a member may comprise comparing the recipient's identifying information (e.g. name and e-mail address) to the identifying information of the members to see if there is a match. If the query 312 determines that the recipient is a member then the method proceeds to step 314.

In step 314 the CA 104 retrieves the recipient's public key certificate from the repository 112 and sends the public key certificate to the member end entity 106. In some embodiments the public key certificate is sent to the requestor via a SSL socket. In step 316 the secure transmission module 124 receives the public key certificate sent in step 314 and registers the public key certificate with the electronic data module 122. The secure transmission module 124 then encrypts the electronic data using the received public key certificate and sends the encrypted electronic data to the recipient. In some embodiments the secure transmission module 124 may also digitally sign the electronic data using the sender's private key prior to sending the electronic data to the recipient. The private key used for signing may be the same private key that is used to decrypt electronic data sent to the member or it may be a special private key used only for signing. Digitally signing electronic data may comprise generating a hash value from the electronic data and then encrypting the hash value using the private key.

If query 312 determines that the recipient is not a member then the CA 104 may generate a public and private key pair and a corresponding non-member public key certificate for the recipient. In some cases the CA 104 may only generate the public and private key pair and corresponding non-member public key certificate if at least one predetermined criterion is met. For example, the method may proceed to query 318 where the CA 104 first checks the member's non-member certificate status indicator to determine if the member has an available non-member certificate. Alternatively, the method may proceed to step 322 where the CA 104 first checks if the CA is an approved recipient based on the policy of the CA 104. In other cases the method moves directly to step 330 where the public and private key pair and corresponding public key certificate are generated.

In query 318 the CA 104 determines if the requestor has an available non-member certificate. Typically this involves checking the non-member certificate status indicator. As described above, in some cases the non-member certificate status indicator is a number that indicates the number of non-member certificates available to the member. In this case each time a non-member certificate is generated the non-member status indicator for the requesting member is reduced. In other cases the non-member certificate status indicator is a Boolean value that indicates whether the member has an available non-member certificate. The Boolean value may be tied to a particular time period. For example, a member may have an unlimited number of available non-member certificates for a period of three months. After the three months has expired the Boolean value is flipped and the member has no available non-member certificates. In some cases the member will be able to purchase an additional time period after the three months has expired.

If query 318 determines that the requester does not have an available non-member certificate then the method proceeds to step 320. In step 320, the CA 104 notifies the user that they have no available non-member certificates. The sender may be notified by an e-mail message and the e-mail message may include a link that when activated displays a non-member certificate obtaining screen which allows the sender to obtain additional non-member certificates. The non-member certificate obtaining screen may be a webpage or a pop-up window that allows the member to obtain additional non-member certificates. For example, the non-member certificate obtaining screen may be a webpage that allows members to purchase additional non-member certificates.

If query 318 determines that the requestor has at least one unused non-member certificate then the method proceeds to step 322.

In step 322 the CA 104 sends a request to the RA 102 for the approval or rejection of the recipient.

In query 324, the RA 102 receives the request sent in step 322 and either approves or rejects the recipient based on the policy of the CA 104. For example, the policy may be to reject e-mail addresses from a specific country or from a public e-mail service such as Hotmail.

If the recipient is rejected in query 324 then the method proceeds to step 326. In step 326 the RA sends a rejection notice to the CA 104. In step 328 the CA 104 receives the rejection notice sent in step 326 and sends a message to the user notifying them of the rejection. If the user receives a message that the recipient has been rejected they will be unable to send encrypted electronic data to the selected recipient and accordingly method 300 comes to a premature end.

If the recipient is approved in query 324 then the method proceeds to step 330. In step 330, the CA 104 generates at least one public and private key pair, a non-member public key certificate and a Certificate Signing Request (CSR) and sends it to the RA 102. Where the sender indicated in step 310 that the CA 104 was to generate a second certificate for signing, the CA 104 may generate a second public and private key pair, a second non-member public key certificate and a second Certificate Signing Request. The subject name of the non-member public key certificate(s) may be set to a generic name, such as “free certificate” or “non-member certificate”, as opposed to the name of the recipient.

In step 332 the CA 104 signs the certificate(s) generated in step 330. The CA 104 then stores the private key(s) and the corresponding non-member public key certificate(s) in the repository 112.

In step 334 the CA 104 sends the signed non-member public key certificate(s) to the sender. The non-member public key certificate(s) may be sent to the sender via an SSL socket. In step 334, the CA 104 also sends an invitation to the recipient to receive their private key(s) and corresponding non-member public key certificate(s). In some embodiments the invitation is an e-mail message.

In step 336 the secure transmission module 124 receives the non-member public key certificate(s) sent by the CA 104 in step 334. The secure transmission module 124 registers the certificate(s) with the electronic data module 122 and the certificate storage application 126. The secure transmission module 124 then uses the public key certificate to encrypt the electronic data. In some cases the secure transmission module 124 may also be configured to digitally sign the electronic data using the sender's private key. The private key used for authentication or signing may be the same private key that is used for encryption or it may be a separate key that is only used for signing. Where the electronic data is an e-mail message the secure transmission module 124 may also modify the subject of the e-mail to include a message notifying the recipient that they must contact the sender to retrieve the secure PIN. The message may say something like: “Call the sender for the secure pin”. The encrypted electronic data is then sent to the recipient.

Accordingly, a non-member recipient may receive two messages. The first is the encrypted electronic data generated by the sender and the second is the invitation generated by the CA 104. The recipient may not be able to decrypt the electronic data from the sender until the recipient retrieves its private key from the CA 104. In some embodiments the recipient may not be able to retrieve their private key from the CA 104 until they obtain the secure PIN from the sender. The secure PIN may be obtained from the sender via telephone or any other secure means.

In one embodiment, the recipient retrieves their private key and corresponding non-member public key certificate via a web interface. In this embodiment the invitation generated by the CA 104 contains a link to a website. When the user clicks on this link they are taken to a secure website where they are prompted to enter their identifying information. The identifying information may include the recipient's first name, last name, e-mail address and the PIN number entered by the sender. Where the CA 104 generated a signing certificate for the non-member, the user may also be asked to provide a second PIN number which will be used to encrypt the private signing key and corresponding non-member public key certificate. Once the required information is entered, a new link is provided that, when clicked, downloads the private key(s) and the corresponding non-member public key certificate(s) to the non-member end entity 108 associated with the recipient. Note that where the sender entered a PIN number for the recipient, the CA 104 may encrypt the private encryption key and corresponding non-member public key certificate using the PIN prior to transmission. Where the CA 104 generated a signing certificate and the user specified a second PIN number, the CA 104 may encrypt the private signing key and corresponding non-member public key certificate with the second PIN. Once downloaded, the user then must manually register the certificate(s) and private key(s) with their electronic data module 122.

In an alternative embodiment, the recipient retrieves their private key(s) and corresponding non-member public key certificate(s) by downloading and installing the certificate manager module 120 and the secure transmission module 124. In this embodiment the invitation generated by the CA 104 contains a link. When the user clicks on this link the certificate manager module 120 and secure transmission module 124 are automatically downloaded and installed on the non-member end entity 108. Once installed, the certificate manager module 120 may automatically pop-up a dialog box prompting the user to enter their identifying information. Where a signing certificate was generated for the recipient the user may have to enter a second PIN number for encryption of the private signing key. Once all of the identifying information is entered the certificate manager application 120 may send an enrollment request to the CA 104. The CA 104 verifies the identifying information of the recipient and if it checks out, then the CA 104 sends the recipient their private key(s) and corresponding non-member public key certificate(s). The certificate manager module 120 can receive and potentially decrypt the private key(s) and public key certificate(s). Once received, the certificate manager module 120 automatically installs the private key(s) and public key certificate(s) with the electronic data module 122 and the certificate storage module 126.

The certificate manager module 120 may also automatically download the public key certificate of the sender from the CA 104 and register it with the electronic data module 122 and the certificate storage module 126. This provides the user with the capability of immediately sending an encrypted response to the original sender.

One disadvantage of this alternative embodiment is that it will not work if the recipient does not have sufficient privileges on their computer to be able to install software.

In another embodiment, a member of an encryption system securely sends electronic data (e.g. e-mail) to a recipient using a web-based electronic data interface (e.g. a web mail interface). In some cases the CA 104 further includes an electronic data server application (e.g. an e-mail server application), which is accessible to members of the encryption system via a web-interface. In other cases the electronic data server application will reside on a separate computer that is in communication with the CA 104.

When a user accesses the web-interface, via a web browser, for example, the user may be prompted for information (e.g. name, e-mail address, PIN) that identifies the user as a member. If the identifying information is verified, the user is provided with an interface which allows them to generate electronic data to be sent to a selected recipient. The interface may include a button or other means to initiate encryption and/or signing of the electronic data prior to sending it to the recipient. This button will be referred to as the “send secure” button.

When the “send secure” button is clicked, or otherwise activated, the CA 104 determines whether the recipient is a member of the encryption system. Determining whether the recipient is a member may involve comparing the identifying information of the recipient (e.g. name and e-mail address) to the identifying information of the members. If the recipient is a member then the CA 104 retrieves the member public key certificate for the recipient from the repository 112 and encrypts the electronic data using the recipient's public key certificate. The CA 104 then sends the encrypted electronic data to the recipient. In some cases the CA 104 will also sign the electronic data using the sender's private key prior to sending the encrypted electronic data to the recipient. The private key used for signing may be the same private key used for encryption or it may be a separate key used only for authentication.

If the recipient is not a member then the CA 104 asks the user if they wish to initiate generation of a certificate for the recipient. If the user indicates that they do not wish to initiate generation of a certificate for the recipient then the message will be sent unencrypted to the recipient. If the user indicates that they wish to initiate generation of a certificate for the recipient, the user will be prompted for the identifying information for the recipient. The identifying information may include the first name, last name, e-mail address and PIN number of the recipient. The user may also be asked whether they wish the CA 104 to generate a signing certificate for the recipient in addition to an encryption certificate.

Once all of the identifying information has been entered, the CA 104 may generate a public and private key pair and a corresponding non-member public key certificate. Where the sender specified that the CA 104 generate a signing certificate in additional to the encryption certificate the CA 104 may also generate a second public and private key pair and a corresponding non-member public key certificate.

In some cases the CA 104 may only generate the public and private key pair(s) and corresponding non-member public key certificate(s) if at least one predetermined criterion is met. For example, the CA 104 may only generate the public and private key pair(s) if the sender member has an available non-member certificate. The CA 104 may also only generate the public and private key pair(s) if the recipient is approved based on the CA 104 policy. For example, the policy may be to reject e-mail address that are associated with particular countries. In other cases the CA 104 generates the public and private key pair(s) and corresponding public key certificate(s) automatically upon receiving the identifying information.

If at least one public and private key pair and corresponding non-member public key certificate are generated, the CA 104 stores the private key(s) and corresponding non-member public key(s) in the repository 112. The CA 104 then encrypts the electronic data using the public key and sends it to the recipient. In some cases the CA 104 may also sign the electronic data using the sender's private key. The private key used for authentication may be the same key as used for encryption or it may be a separate key used solely for signing. The CA 104 also sends an invitation (e.g. e-mail message) to the recipient inviting them to retrieve their private key(s) and corresponding non-member certificate(s). The recipient may obtain their private key(s) and corresponding non-member public key certificate(s) in any of the manners previously described.

In another embodiment, a non-member of an encryption system securely sends electronic data (e.g. e-mail) to a recipient using a non-member end entity 108. In this embodiment, the non-member end entity 108 has electronic data module 122 and a secure transmission module 124. The non-member may obtain the secure transmission module 124 by downloading it from a publicly available site or through other suitable means. This configuration allows a non-member to securely send electronic data (e.g. e-mail) in the same manner as was described in relation to method 300. Specifically, the non-member can obtain a certificate for a member or non-member recipient directly from the CA 104 to be able to securely send the member or non-member electronic data (e.g. e-mail).

In a further embodiment, a non-member of an encryption system securely sends electronic data (e.g. e-mail) to a recipient via a web services-based interface provided by an electronic data service provider (e.g. an e-mail service provider). In this embodiment the electronic data service provider provides a web-based electronic data service to its customers. The customers can access this service using, for example, a web browser. Full access to the service will typically only be given when the user validates their identity through a login or similar process.

Once the user has validated their identity they may be provided with an interface which allows them to generate electronic data to be sent to a selected recipient. The interface may include a button that initiates encryption and/or signing of the electronic data prior to sending the electronic data to the recipient. This button will be referred to as the “send secure” button.

When the “send secure” button is clicked, or otherwise activated, the electronic data service provider sends a request to the CA 104 via the CA 104 web service. In response to the request the CA 104 determines whether the recipient is a member of the encryption system. Determining whether the recipient is a member may involve comparing the recipient's identifying information with the identifying information of the members. If recipient is a member then the CA 104 retrieves the recipient's public key certificate from the repository 112 and sends the certificate to the electronic data service provider.

If the CA 104 determines that the recipient is not a member then the CA 104 informs the electronic data service provider. The service provider then prompts the user for the identifying information for the recipient. This may include the first name, last name, e-mail address and PIN number for the recipient. The user may also be asked whether they wish the CA 104 to generate a signing certificate for the recipient in addition to an encryption certificate.

Once all of the identifying information has been entered, the service provider sends a request for a non-member certificate to the CA 104. In response to the request, the CA 104 may generate a public and private key pair and an associated non-member public key certificate. Where the sender specified that the CA 104 generate a signing certificate in addition to the encryption certificate then the CA 104 may also generate a second public and private key pair and an associated non-member public key certificate.

In some cases the CA 104 only generates the public and private key pair(s) and corresponding non-member public key certificate(s) if at least one predetermined criterion is met. For example, the CA 104 may only generate the public and private key pair(s) if the recipient is approved based on the CA 104 policy. For example, the CA 104 policy may be to reject recipients with an e-mail address from a specific country or countries.

If at least one public and private key pair and corresponding non-member public key certificate are generated, the CA 104 stores the private key(s) and the corresponding non-member public key certificate(s) in the repository 112. The CA 104 also sends the non-member public key certificate(s) to the electronic data service provider and sends an invitation to the non-member recipient to retrieve their private key(s) and corresponding non-member public key certificate(s).

If the electronic data service provider receives at least one public key certificate from the CA 104 (either because one already existed (member certificate) or because one was created (non-member certificate)) the electronic data service provider encrypts the electronic data using the received public key certificate and then sends the encrypted electronic data to the recipient. In some cases the electronic data service provider will also sign the electronic data using the sender's private key. The private key used for signing may be the same private key used for encryption or it may be a separate key.

The recipient may obtain their private key(s) corresponding non-member public key certificate(s) in any of the manners previously described.

The embodiments described herein have been shown and described by way of a number of examples. It will be apparent to those skilled in the art that changes and modifications to the described embodiments may be made without departing from the substance and scope of the described embodiments, as defined in the appended claims.

1. A method for providing encryption, the method comprising:
a) transmitting a request from a sender to a database for a public key for a selected recipient, the database being configured to store for each member in a plurality of members a member public key for encrypting electronic data;
b) determining if the selected recipient is in the plurality of members, and;
c) if the selected recipient is in the plurality of members, then executing a member procedure, the member procedure comprising transmitting from the database to the sender the member public key stored in the database for the selected recipient;
d) if the selected recipient is not in the plurality of members, then executing a non-member procedure, the non-member procedure comprising determining if at least one predetermined criterion is met, and, if the at least one predetermined criterion is met, generating a non-member public key for encrypting electronic data and a non-member private key for decrypting the electronic data encrypted using the non-member public key; otherwise, if the at least one predetermined criterion is not met the non-member public key and the non-member private key are not generated.

2. The method of claim 1, wherein the sender is a member of the plurality of members.

3. The method of claim 2, wherein
the database is further configured to store for each member of the plurality of members a non-member key status indicator for indicating whether a non-member key is available; and
determining if the at least one predetermined criterion is met comprises checking the non-member key status indicator to determine if the non-member key is available.

4. The method of claim 3, wherein the non-member procedure further comprises, if the non-member key is unavailable, transmitting a non-member key message to the sender to notify the sender that there are no non-member keys available.

5. The method of claim 4, wherein the non-member key message comprises a link that, when activated by the sender, displays a non-member key obtaining screen.

6. The method of claim 3, wherein
the non-member key status indicator indicates a number of non-member keys available, and;
the non-member procedure further comprises reducing the number of non-member keys available when the non-member public key and the non-member private key are generated.

7. The method of claim 1, wherein the electronic data is an e-mail message.

8. The method of claim 1, wherein the non-member procedure further comprises, storing the non-member public key and the non-member private key on the database.

9. The method of claim 8, wherein the non-member procedure further comprises transmitting an invitation to the selected recipient to retrieve the non-member private key from the database.

10. The method of claim 9, wherein the invitation is an e-mail message.

11. The method of claim 10, wherein the invitation comprises a link that, when activated by the selected recipient, transmits the non-member private key to the selected recipient.

12. The method of claim 4, wherein determining if the at least one predetermined criterion is met comprises determining whether the selected recipient is approved.

13. The method of claim 12, wherein
the selected recipient is associated with an address, and
determining whether the selected recipient is approved comprises evaluating the address associated with the selected recipient.

14. The method of claim 1, wherein
the database is further configured to store for each member of the plurality of members a member certificate, the member certificate comprises the public key for the member,
the member public key for the selected recipient is transmitted to the member within the member certificate, and
the non-member procedure further comprises generating a non-member certificate comprising the non-member public key.

15. A method for providing encryption, the method comprising:
a) transmitting a request from a sender to a database for a public key for a selected recipient, the database being configured to store for each member in a plurality of members a member public key for encrypting electronic data;
b) determining if the selected recipient is in the plurality of members, and;
c) if the selected recipient is in the plurality of members, then executing a member procedure, the member procedure comprising transmitting from the database to the sender the member public key stored in the database for the selected recipient;
d) if the selected recipient is not in the plurality of members, then executing a non-member procedure, the non-member procedure comprising generating a non-member public key for encrypting electronic data and a non-member private key for decrypting the electronic data encrypted with the non-member public key.

16. The method of claim 15, wherein the sender is a member of the plurality of members.

17. The method of claim 15, wherein the electronic data is an e-mail message.

18. The method of claim 15, wherein the non-member procedure further comprises, storing the non-member public key and the non-member private key on the database.

19. The method of claim 18, wherein the non-member procedure further comprises transmitting an invitation to the selected recipient to retrieve the non-member private key from the database.

20. The method of claim 19, wherein the invitation is an e-mail message.

21. The method of claim 19, wherein the invitation comprises a link that, when activated by the selected recipient, transmits the non-member private key to the selected recipient.

22. The method of claim 15, wherein
the database is further configured to store for each member of the plurality of members a member certificate, the member certificate comprising the member public key;
the member public key is transmitted to the member within the member certificate; and
the non-member procedure further comprises generating a non-member certificate comprising the non-member public key.

23. A system for providing encryption, the system comprising:
a database comprising:
a storage module configured to store, for each member in a plurality of members, a member public key for encrypting electronic data,
a communication module configured to receive a request from a sender for the member public key for a selected recipient,
a key generation module configured, upon activation, to generate a non-member public key for encrypting electronic data and a non-member private key for decrypting the electronic data encrypted with the non-member public key, and
a key management module configured to determine whether the selected recipient is in the plurality of members, and if the selected recipient is in the plurality of members, transmit to the sender the member public key stored in the database for the selected recipient; and if the selected recipient is not in the plurality of members, then activate the key generation module; and
an end entity associated with the sender, the end entity being configured to transmit the request.

24. The system of claim 23, wherein the sender is a member of the plurality of members.

25. The system of claim 24, wherein the key generation module is further configured to determine if at least one predetermined criterion is met, and if the predetermined criterion is met, generate the non-member public key and non-member private key for the selected recipient, and otherwise the non-member public key and the non-member private key are not generated.

26. The system of claim 25, wherein
the storage module is further configured to store for each member of the plurality of members a non-member key status indicator for indicating whether a non-member key is available; and
determining if the at least one predetermined criterion is met comprises checking the non-member key status indicator to determine if the non-member key is available.

27. The system of claim 26, wherein
the non-member key status indicator indicates a number of non-member keys available, and;
the key generation module is further configured to reduce the number of non-member keys available when the non-member public key and the non-member private key are generated.

28. The system of claim 27, wherein each member of the plurality of members is associated with a member level and an initial number of non-member keys available, the initial number of non-member keys available being based on the member level.

29. The system of claim 23, wherein the end entity comprises:
a key storage module configured to store a plurality of public keys, wherein each public key is associated with a recipient,
an electronic data module configured to generate electronic data to be transmitted to the selected recipient, and
a secure transmission module configured to:
determine whether the key storage module contains a public key for the selected recipient,
if the key storage module contains the public key for the selected recipient, then encrypt the electronic data using the stored public key, and
if the key storage module does not contain the public key for the selected recipient, then transmit the request to the database, and if the public key is received from the database in response to the request, encrypt the electronic data using the received public key.

30. The system of claim 29, wherein the electronic data module comprises a secure transmission link that, when activated by the member, activates the secure transmission module.

31. The system of claim 23, wherein the electronic data is an e-mail message.

32. The system of claim 23, wherein the key generation module is further configured to store the non-member public key and the non-member private key on the storage module.

33. The system of claim 32, wherein the key generation module is further configured to transmit an invitation to the selected recipient to retrieve the non-member private key from the database when the non-member private key is generated.

34. The system of claim 33, wherein the invitation comprises a link that, when activated by the selected recipient, transmits the non-member private key to the selected recipient.

35. The system of claim 23, wherein
the storage module is further configured to store for each of the members of the plurality of members a member certificate comprising the member public key, and
the key generation module is further configured to generate a non-member certificate for the selected recipient comprising the non-member public key.

36. The system of claim 35, wherein,
each of the plurality of member certificates is associated with a member validity period that defines the period for which the member certificate is valid,
the non-member certificate is associated with a non-member validity period that defines the period for which the non-member certificate is valid, and
the non-member validity period is shorter than the member validity period.

37. The system of claim 36, wherein the key management module is further configured to monitor the non-member validity period and when the non-member validity period expires transmit a membership invitation to the selected recipient to become a member.

38. The system of claim 23, wherein determining if the at least one predetermined criterion is met comprises determining whether the selected recipient is approved.

39. The system of claim 38, wherein
the selected recipient is associated with an address, and
determining whether the selected recipient is approved comprises evaluating the address associated with the selected recipient.
